(19) United States
(12) Patent Application Publication
(10) Pub. No.: US 2003/0115285 A1
(43) Pub. Date: Jun. 19, 2003

(54) Web-based inventory management information system

(75) Inventors: Ti-Chin Lee, Taipei (TW); Po-Wen Lu, Taipei (TW); Tzu-Hui Hsu, Taipei (TW); Hsu-Yun Lu, Taipei (TW); Shu-Hui Chuang, Taipei (TW)

Correspondence Address: EDWARDS & ANGELL, LLP, P.O. BOX 9169, BOSTON, MA, 02209, US

(73) Assignee: Inventec Corporation

(21) Appl. No.: 10/163,734

(22) Filed: Jun. 6, 2002

(30) Foreign Application Priority Data
Dec. 18, 2001 (TW) 90131295

(51) Int. Cl. G06F 15/16; G06F 17/60

(52) U.S. Cl. 709/217; 705/28

(57) ABSTRACT

A Web-based inventory management information system is proposed, which allows a company's inventory management taskforce to browse via Internet for all inventory-related information, including the incoming plans of inter-company purchase order, direct shipment, and local supply, as well as the company's current and future inventory stock, sales orders, market forecast, and so on, for the purpose of allowing everyone on the company's inventory management taskforce to learn and be well-informed of such information quickly and conveniently via Internet. The proposed Web-based inventory management information system is characterized by the use of a Web server to serve up all the inventory-related information in an online manner through Internet, so that everyone on the company's inventory management taskforce can conveniently gain access to all the inventory-related information via Internet.

### BACKGROUND OF THE INVENTION

1. Field of the Invention

This invention relates to Web-based information technology, and more particularly, to a Web-based inventory management information system which allows a company's inventory management taskforce to browse via a network system, such as intranet or Internet, for all inventory-related information, such as inter-company purchase order, direct shipment, and local supply, as well as future inventory stock, sales orders, and forecast demand, and so on, for the purpose of allowing all inventory management taskforce in the company to quickly and conveniently gain access to all the inventory-related information to make the inventory management more efficiently.

2. Description of Related Art

In the manufacture industry, such as the CEM (Contract Electronics Manufacture) industry, the manufacturer can acquire components from three various sources: (1) inter-company purchase order; (2) direct shipment from supplier; and (3) local supply. In order to allow high throughput to the manufacture, it is important to allow everyone on the inventory management taskforce in the company to quickly and conveniently learn all the details and related data about the incoming plan of each of these various sources of supply so as to carry out the inventory control tasks more efficiently and effectively.

Conventionally, the CEM inventory control tasks for the above-mentioned three sources of supply is to create printed-type or electronic-type of forms, including an inter-company purchase order form, a direct shipment form, and a local supply form, for the inventory management taskforce to handle the details and related data thereof.

One drawback to the use of printed-type of forms for inventory control tasks, however, is that it would be highly laborious and difficult to organize, access, and do real-time updates to these forms; and therefore, the overall efficiency of the inventory management would be unsatisfactory.

The electronic-type of forms can be quickly and conveniently updated and accessed. However, traditionally, these electronic-type of forms are typically stored on just a small number of computers, which would be laborious and time-consuming to be distributed to everyone on the inventory management taskforce, resulting in low efficiency of the inventory control tasks.

Furthermore, there is presently no way to allow the inventory management taskforce to quickly get real-time information in an online manner about its own company's current inventory status and the whole market's forecast to make everyone on the inventory management taskforce well-informed about future purchase orders and market demands.

### SUMMARY OF THE INVENTION

It is therefore an objective of this invention to provide a Web-based inventory management information system, which allows everyone on a company's inventory management taskforce to browse all the details and data of inventory-related information quickly and conveniently in an online manner so that the inventory control tasks can be carried out more efficiently.

It is another objective of this invention to provide a Web-based inventory management information system, which is capable of providing online information about the details of the respective incoming plans of various sources of supply, so as to allow everyone on the inventory management taskforce to be well-informed of such information conveniently via Internet to make the inventory control tasks more effectively.

Broadly recited, the Web-based inventory management information system according to the invention comprises: (a) a Web server, which is used to serve up an inventory-management information Web page including an inter-company purchase order incoming plan, a direct shipment incoming plan, a local supply incoming plan, a current and future inventory stock report, and a sales order and market forecast report; and (b) a network system, which is linked to the Web server, and which allows at least one workstation to be linked to the Web server; wherein when the workstation is linked via the network system to the Web server, the workstation can open the inventory-management information Web page to thereby browse the contents of the inter-company purchase order incoming plan, the direct shipment incoming plan, the local supply incoming plan, the current and future inventory stock report, and the sales order and market forecast report.

The Web-based inventory management information system according to the invention is characterized by the use of a Web server to serve up inventory-related information in an online manner, including an online inter-company purchase order incoming plan, an online direct shipment incoming plan, and an online local supply incoming plan; and further including an online current and future inventory stock report and an online sales order and market forecast report, which allows everyone on the inventory management taskforce to learn such information quickly and conveniently via Internet connection, so that all the inventory control tasks can be carried out more efficiently and effectively.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the system architecture of the Web-based inventory management information system according to the invention; and

FIGS. 2A-2C are screen images showing the various forms and data displayed by the Web-based inventory management information system of the invention on the screen of a linked workstation.

### DETAILED DESCRIPTION OF PREFERRED EMBODIMENTS

The Web-based inventory management information system according to the invention is disclosed in full details in the following with reference to the accompanying drawings.

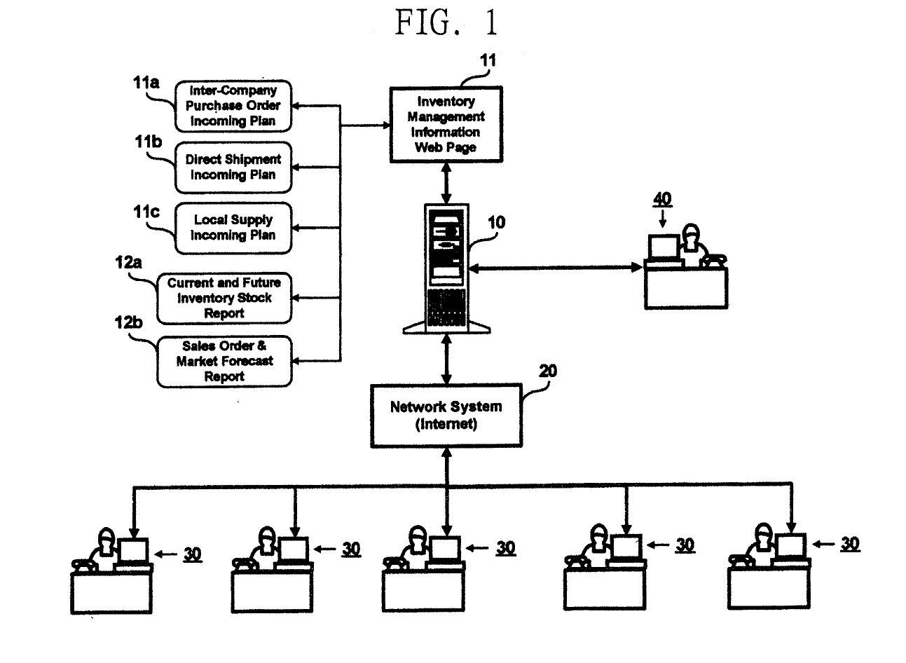

Referring to FIG. 1, the Web-based inventory management information system of the invention comprises: (a) a Web server 10; and (b) a network system 20, which can be either the Internet or the company's intranet system, and which is linked to the Web server 10 to allow one or more workstations 30 to be linked to the Web server 10.

The Web server 10 is used to serve up an inventory-management information Web page 11 which includes at least three online forms of reports: an inter-company purchase order incoming plan 11a, a direct shipment incoming plan 11b, and a local supply incoming plan 11c; and in addition, includes a current and future inventory stock report 12a, a sales order and market forecast report 12b, and so on. The Web server 10 allows any authorized user to use his/her workstation 30 to link thereto via the network system 20 and gain access to the contents of the inter-company purchase order incoming plan 11a, the direct shipment incoming plan 11b, the local supply incoming plan 11c, the current and future inventory stock report 12a, and the sales order and market forecast report 12b. In addition, the Web server 10 is further linked to a Webmaster workstation 40 which is used by the Web system administrator to create and update the abovementioned online reports 11a, 11b, 11c, 12a, 12b.

The inter-company purchase order incoming plan 11a is used to provide online information about the details and related data of the incoming plan of the source of inter-company purchase order, allowing everyone on the inventory management taskforce to learn such information quickly and conveniently in an online manner via the network system 20, so that the inventory control tasks on the incoming plan of the source of inter-company purchase order can be carried out more efficiently and effectively.

The direct shipment incoming plan 11b is used to provide online information about the details and related data of the incoming plan of the source of direct shipment, allowing everyone on the inventory management taskforce to learn such information quickly and conveniently in an online manner via the network system 20, so that the inventory control tasks on the incoming plan of the source of direct shipment can be carried out more efficiently and effectively.

The local supply incoming plan 11c is used to provide online information about the details and related data of the incoming plan of the source of local supply and all related data, allowing everyone on the inventory management taskforce to learn such information quickly and conveniently in an online manner via the network system 20, so that the inventory control tasks on the incoming plan of the source of local supply can be carried out more efficiently and effectively.

The current and future inventory stock report 12a is used to provide online information about the status of current (on-hand) and future stock of the company, allowing the inventory management taskforce to learn such information quickly and conveniently in an online manner via the network system 20, so that the tasks on the overall inventory control can be carried out more efficiently and effectively.

The sales order and market forecast report 12b is used to provide online information about the company's current sales orders and the market forecast, allowing the inventory management taskforce to be well-informed of such information quickly and conveniently through Internet-connection to the Web server 10, whereby the company's sales prospect can be more energized to increase the profit of the company.

The above-mentioned online reports 11a, 11b, 11c, 12a, 12b can be created and updated by using conventional Web page authoring tools on the Webmaster workstation 40. Since the creating of these online reports 11a, 11b, 11c, 12a, 12b employs conventional techniques, description thereof will not be further detailed.

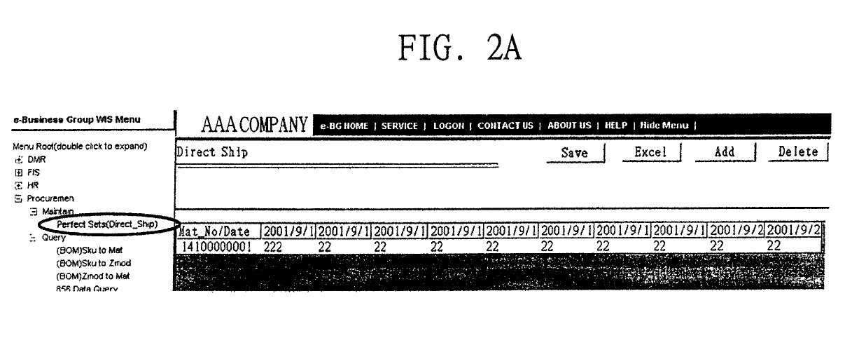

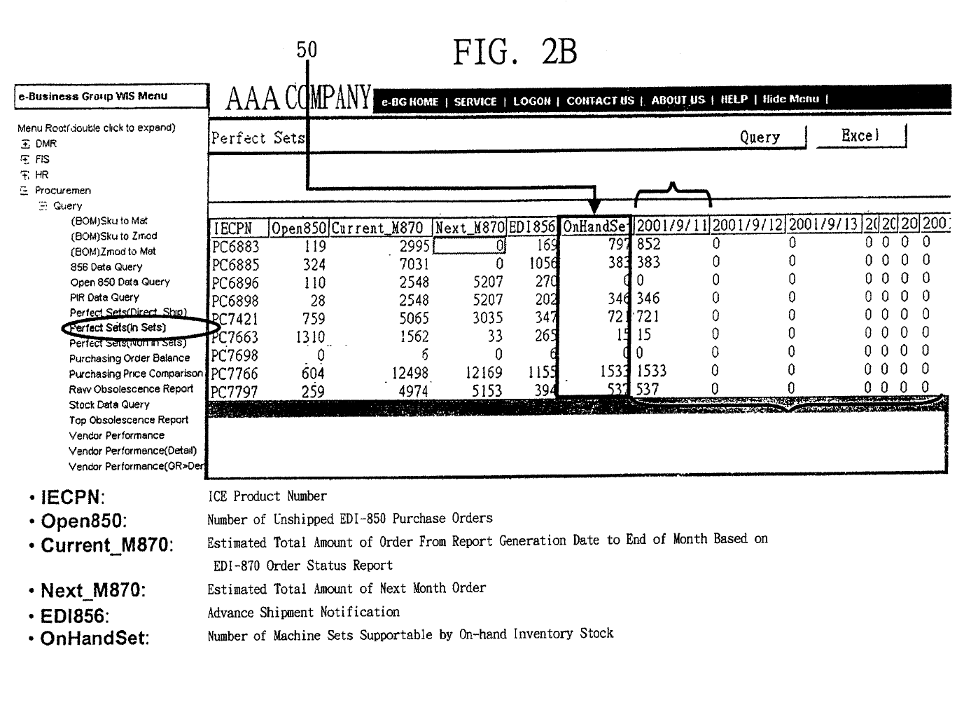

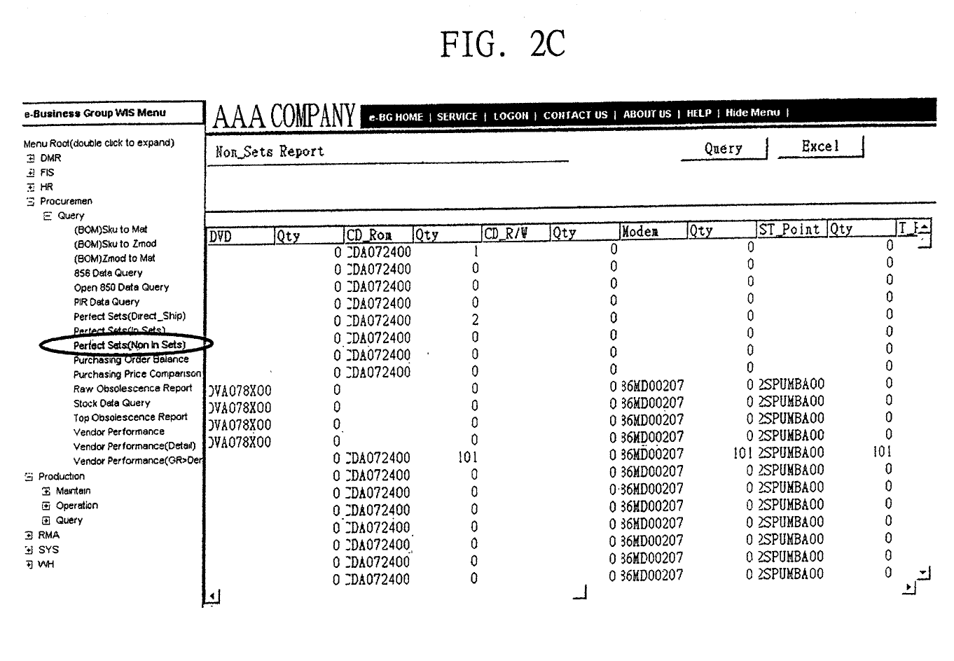

FIGS. 2A-2C are screen images showing the various online reports and data displayed by the Web-based inventory management information system of the invention on the screen of any one of the linked workstations 30. It is to be noted that the screen images shown here are practical examples of the invention, and are not intended to limit the scope of the invention. FIG. 2A shows an example of the on-screen display of the direct shipment incoming plan 11b; FIG. 2B shows the company's current inventory stock and the incoming plan on that day; and FIG. 2C shows an online non-sets report. Since the techniques for creating these online reports shown in FIGS. 2A-2C are conventional art, description thereof will not be further detailed.

In FIG. 2B, for example, the reference numeral 50 points to a data field used to indicate the number of machine sets supportable for manufacture by the company's current inventory stock plus the incoming components on the present date (Sep. 11, 2001). This data field shows the related data for the present date as well as for the next 7 days.

The workstations 30 are each a personal computer unit, such as desktop PC or note PC, each being equipped with a Web browser program, such as Microsoft Internet Explorer or Netscape Navigator. Each of these workstations 30 can be linked via the network system 20 to the Web server 10, allowing the user to use the Web browser program to browse through the contents of each of the online reports 11a, 11b, 11c, 12a, 12b.

During operation, if anyone in the inventory management taskforce wants to learn the company's current inventory stock, he/she needs just to first link his/her workstation 30 via the network system 20 to the Web server 10, and then use a Web browser program, such as Microsoft Internet Explorer or Netscape Navigator, to gain access to the inventory-management information Web page 11, whereby the user can browse the contents of the inter-company purchase order incoming plan 11a, the direct shipment incoming plan 11b, the local supply incoming plan 11c, the current and future inventory stock report 12a, and the sales order and market forecast report 12b, simply by clicking on the related links in the inventory-management information Web page 11.

In conclusion, the invention provides a Web-based inventory management information system, which is characterized by the use of a Web server to serve up all inventory-related information in an online manner, including an online inter-company purchase order incoming plan, an online direct shipment incoming plan, and an online local supply incoming plan; and further including an online current and future inventory stock report and an online sales order and market forecast report, which allows everyone on the inventory management taskforce to learn such information quickly and conveniently via Internet connection, so that all the inventory control tasks can be carried out more efficiently and effectively.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A Web-based inventory management information system, which comprises:
(a) a Web server, which is used to serve up an inventory-management information Web page including an inter-company purchase order incoming plan, a direct shipment incoming plan, a local supply incoming plan, a current and future inventory stock report, and a sales order and market forecast report; and
(b) a network system, which is linked to the Web server, and which allows at least one workstation to be linked to the Web server;
wherein
when the workstation is linked via the network system to the Web server, the workstation can open the inventory-management information Web page to thereby browse the contents of the inter-company purchase order incoming plan, the direct shipment incoming plan, the local supply incoming plan, the current and future inventory stock report, and the sales order and market forecast report.

2. The Web-based inventory management information system of claim 1, wherein the network system is Internet.

3. The Web-based inventory management information system of claim 1, wherein the workstation utilizes a Web browser program to browse the contents of the inventory-management information Web page on the Web server.

4. The Web-based inventory management information system of claim 3, wherein the Web browser program is Microsoft Internet Explorer.

5. The Web-based inventory management information system of claim 3, wherein the Web browser program is Netscape Navigator.

6. A Web-based inventory management information system, which comprises:
(a) a Web server, which is used to serve up an inventory-management information Web page including an inter-company purchase order incoming plan, a direct shipment incoming plan, a local supply incoming plan, a current and future inventory stock report, and a sales order and market forecast report; and
(b) a network system, which is linked to the Web server, and which allows at least workstation to be linked to the Web server;
wherein
when the workstation is linked via the network system to the Web server, the workstation can utilize a Web browser program to open the inventory-management information Web page to thereby browse the contents of the inter-company purchase order incoming plan, the direct shipment incoming plan, the local supply incoming plan, the current and future inventory stock report, and the sales order and market forecast report.

7. The Web-based inventory management information system of claim 6, wherein the network system is Internet.

8. The Web-based inventory management information system of claim 6, wherein the Web browser program is Microsoft Internet Explorer.

9. The Web-based inventory management information system of claim 6, wherein the Web browser program is Netscape Navigator.
